(19) United States
(12) Patent Application Publication
(10) Pub. No.: US 2011/0296047 A1
(43) Pub. Date: Dec. 1, 2011

(54) METHOD AND APPARATUS FOR SEAMLESS PLAYBACK OF MEDIA

(75) Inventor: Brian Orr, Cambridge (CA)

(73) Assignee: Sony Corporation, Tokyo (JP)

(21) Appl. No.: 12/791,766

(22) Filed: Jun. 1, 2010

(51) Int. Cl. G06F 3/01; G06F 15/16

(52) U.S. Cl. 709/231; 715/716

(57) ABSTRACT

Methods and apparatus are provided for seamless playback of media files by an application of a computing device. In one embodiment a method includes detecting a user selection for playback of one or more media files by the application, initiating playback of a first media file by the application based on the selection, and determining a time period to pre-load a second media file during playback of the first media file. The method may further include pre-loading data for the second media file, initiating playback of a buffer portion following an endpoint of the first media file, and continuing playback of the second media file following the endpoint of the buffer portion.

### FIELD OF THE INVENTION

The present invention relates generally to processing of media files, and more particularly to a device and methods for seamless playback of a plurality of media files.

### BACKGROUND OF THE INVENTION

Audio and video data can be stored in many formats and processed by a variety of devices. Media playback typically depends on the format of media and type of storage utilized. For example, conventional devices for processing audio data include devices which read data stored on data discs (e.g., compact disc “CD”), and devices configured to electronically store files (e.g., MP3 files). These conventional methods and devices generally allow for playback of one or more media files from a single source. One or more drawbacks of these conventional methods and devices is the ability to provide seamless playback of media. For many users there exists a desire to provide seamless and continuous playback of media data which has not been addressed by conventional methods and devices and/or fails to address one or more drawbacks of these devices and methods.

Disc based players are an example of a conventional type of audio player which is having limited ability for seamless and continuous playback. For example, although CD players are capable of continuous playback of media stored on a compact disc. Data may be stored on CDs a plurality of ways, including as audio data, and as compressed audio files. CDs formatted as an audio disc can be read to allow for transitioning between tracks with interruption in the output of audio as the audio stream is generally encoded as a single physical block of data (with markers indicating the timing positions of the tracks), and not separate files of potentially differing formats. For example, FIG. 1 depicts a graphical representation of audio data 100 which may be provided by a compact disc. This is an exemplary representation storage of audio data as a single block of audio data (e.g., all in the same data format) for a plurality of audio tracks, 105 and 110. Advancing and/or selecting tracks may be based on track markers, shown as 115 and 120, indicating the start and end locations of the different tracks. Although an audio CD may allow for seamless playback, CD players are limited in their ability to play continuously and seamlessly for periods longer than an audio disc (e.g., approximately 70 minutes).

Some CD players have carousels to allow for a plurality of discs to be read for playback, and to allow for random playback of a plurality of files. This approach however, introduces delay between the playback of tracks and thus, is not seamless. Further, this approach does not allow for playback of media according to varying types of data. Similar drawbacks are presented when using other disc based technologies such as digital video discs (DVD).

Another conventional approach to processing audio relies on the use of software products for playback of two user specified tracks. Referring now to FIG. 2, a graphical representation is shown for processing of audio data according to a conventional method. Users may be able to employ software programs, depicted as 200, to select tracks, shown as track 205 and track 210, based on user commands. This conventional approach may allow for playback of the first track 205 followed by the second track 210. However, this approach is typically limited to media of the same type for playback, and usually from the same source. In addition, this approach requires user operation for selection and placement of the tracks for playback to remove delay. Accordingly, this approach may not be preferred for users desiring seamless playback for a plurality of media files and further may not be suitable for media files of differing types. Thus, although these conventional methods may allow for “sample accurate” playback, these methods are limited in there ability to allow for seamless and continuous playback of a plurality of media files.

Thus, there is a desire to provide seamless playback for a plurality of media files of varying types, including music, audio and/or video that overcomes one or more of the aforementioned drawbacks.

### BRIEF SUMMARY OF THE INVENTION

Disclosed and claimed herein are a device and methods for seamless playback of media files by an application of a computing device. In one embodiment, a method includes detecting a user selection for playback of one or more media files by the application, initiating playback of a first media file by the application based on the user selection, wherein the first media file is output by the computing device, determining a time period to pre-load a second media file, during playback of the first media file, and pre-loading data for the second media file at the time period, wherein a buffer portion including data for an initial playback period of the second media file is pre-loaded. The method further includes initiating playback of the buffer portion following an endpoint of the first media file, wherein data for an initial playback period of the second media file is output by the computing device, and continuing playback of the second media file following the endpoint of the buffer portion, wherein the remaining portion of the second media file is output by the computing device.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a graphical representation of a conventional approach for processing audio data provided by a compact disc (CD);

FIG. 2 depicts a graphical representation of a conventional approach for processing audio data;

FIG. 3 depicts a simplified block diagram of a computing device according to one embodiment of the invention;

FIG. 4 depicts a process for seamless playback of one or more media files according to one or more embodiments of the invention;

FIGS. 5A-5B depict graphical representations of playback of media files according to one or more embodiments of the invention;

FIGS. 6A-6B depict graphical representations of playback of media files according to another embodiment of the invention;

FIG. 7 depicts a graphical representation of a media player application user interface according to one embodiment of the invention; and

FIG. 8 depicts a graphical representation of media player application functions according to one embodiment of the invention.

### DETAILED DESCRIPTION OF THE EXEMPLARY EMBODIMENTS

### Overview and Terminology

One aspect of the present invention relates to seamless playback of one or more media files. In one embodiment, a method is provided for playback of one or more media files seamlessly including loading a portion of a second media file during playback of a first media file. The method may also allow for continuous playback for an extended period of time. One advantage of the invention includes playing media files of different types, and from different sources, by the media player application. In one embodiment, the method includes pre-loading data for a portion of a second or subsequent media file during playback of a first media file. In that fashion, one or more media files of the same or different types and associated with a plurality of sources may be played seamlessly and continuously.

As used herein, “playback” relates to processing and output of audio and/or visual or video data of a media file. Seamless playback relates to playback of a media file immediately following the endpoint of a current media file.

In another embodiment, a media player application is provided which may be performed by a computing device. The media player application may be configured to play one or more media files seamlessly and continuously based on a user selection. According to another embodiment, the media player application may additionally be configured to store user preferences for determining media files to subsequently load, and/or select one or more files based on type.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

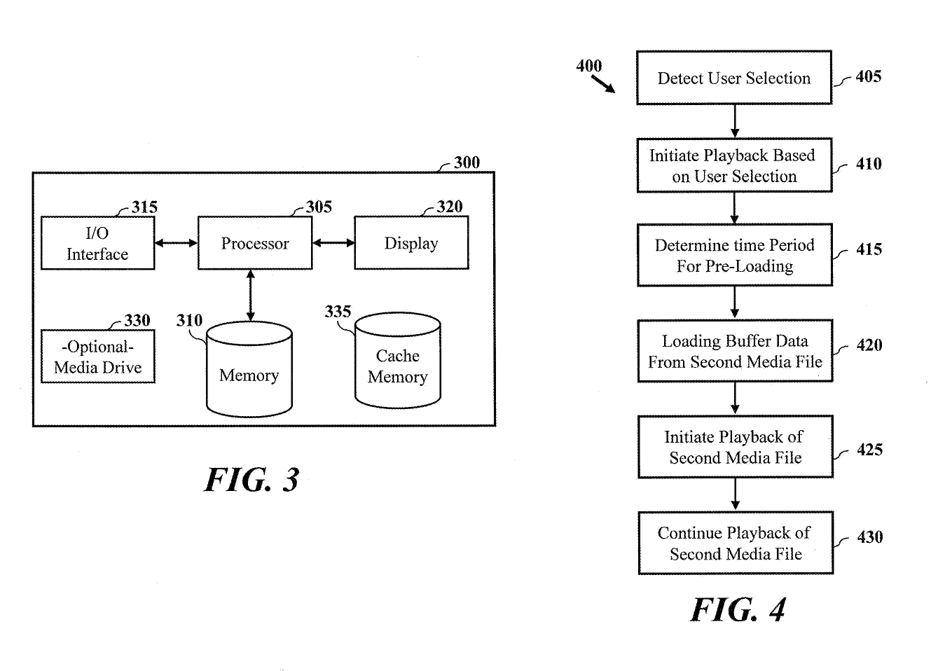

Referring now to the figures, FIG. 3 depicts a simplified block diagram of a computing device according to one or more embodiments of the invention. In one embodiment, computing device 300 relates to a media player, such as one or more of a personal media player and media player application. As shown in FIG. 3, computing device 300 includes processor 305, memory 310, input/output (I/O) interface 315, and display 320. Processor 305 may be configured to control operation of computing device 300 based on one or more computer executable instructions stored in memory 310, including a media player application for seamless playback of one or more media files. Memory 310 may relate to one of RAM and ROM memories and may be configured to store one or more media files, and computer executable instructions for operation of computing device 300. As will be described below in more detail with respect to FIG. 8, processor 300 may be configured to perform one or more media player application functions for seamless playback of media files.

Based on a user selection of I/O interface 315, processor 305 may be configured to run and/or select a media player application for playback of one or more media files. For example, a user selection may initiate playback of one or more media files stored by memory 310 and/or stored by one or more devices coupled to device 300 via I/O interface 315. I/O interface 315 may include one or more buttons for user input, such as a numerical keypad, volume control, channel control, menu controls, pointing device, track ball, mode selection buttons, and playback functionality (e.g., play, stop, pause, forward, reverse, slow motion, etc). In that fashion, a user of computing device 300 can command one or more applications, including an application for seamless playback of one or more media files. Buttons of I/O interface 315 may include hard and soft buttons, wherein functionality of the soft buttons may be based on one or more applications running on computing device 300. I/O interface 315 may be configured to allow for one or more devices to communicate with computing device 300 via wired or wireless communication. In certain embodiments, I/O interface 315 may allow for coupling to an external display and output of audio data via one or more of terminals and speakers.

Display 320 may be employed to display one or more of a user interface of the media application player, menu functions, media tracking, media file identifiers, sources of media files, etc. Display 320 may further be configured to display data received from one or more devices, such as a peripheral device, and external memory.

As will be discussed in more detail below, one advantage of the invention may allow for seamless playback of one or more media files stored on the computing device and provided by one or more devices coupled to the computing device. Further, the media player application may be configured to provide data to allow for continuous output without any delay for conceivable periods of 29,000 years based on the ability to manage billions of media files. In that fashion, one or more media files may be played continuously.

Computing device 300 may be configured to interoperate with one or more external devices for playback of media files stored on the external devices (e.g., portable hard drives, removable memory, portable media players, etc.). In certain embodiments, device 300 may be configured to wirelessly receive one or more media files from a computing device via I/O interface 315. I/O interface 315 may include one or more ports for receiving media data, including ports for removable memory. In another embodiment, computing device 300 may include one or more optical drives, shown as optional optical drive 330, which may be configured to detect and decode one or more media files stored on a disc (e.g., CD, DVD™, Blu-ray™, etc.).

In yet another embodiment, computing device 300 may include optional cache memory 335 for storage of media data, including buffering media data during playback and for pre-loading media data. Although depicted separately, cache memory 335 may be provided by one of processor 305 and memory 310.

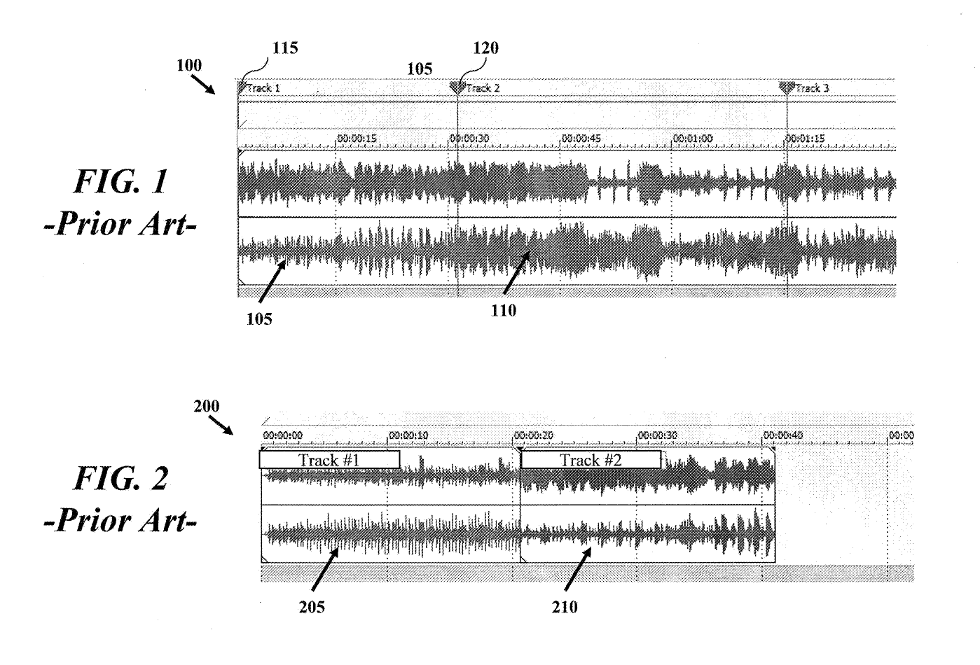

Referring now to FIG. 4, a process is depicted for operation of the computing device of FIG. 1 according to one or more embodiments. Process 400 may be performed by a media player application of a computing device and may be initiated by detection of a user selection of the media player application for playback of one or more media files at block 405. User selections may correspond to selection of a user interface button associated with the media player application for seamless and continuous playback of one or more media files associated with a particular file, folder on a computing device, and one or more sources of media data. As will be discussed below, the media player application may allow for one or more sources to be identified by the user and checked by the media player. The user selection may further trigger the media player based on a selection of a particular folder, desktop icon, and/or selection of a drop-down menu.

Following detection of a user selection at block 405, the computing device may then initiate playback of the user selection at block 410, wherein a first media file is played. Playback by the media player application may include output of audio and/or video data depending on the type of media. In one exemplary embodiment, playback may include a graphical display associated with output levels of audio data. In another embodiment, a visual display and associated audio data may be output based on video data.

In one embodiment, playback at block 410 may include loading a first media file, reading at least a portion of the media data in to a buffer, and turning the media player application on for playback at pre-described audio characteristics (e.g., bit depth, bit rate, etc.) Further, playback of block 410 may include converting and sending audio data to the media player application.

At block 415, the media player application may determine a time period for pre-loading a second media file during playback of the first media file. In one embodiment, the time period for pre-loading is based on the duration of the first media file. For example, the computing device may determine a time period, such as five seconds prior to the endpoint (e.g., termination) of the first media file. Alternatively, when a first media file is relatively short, or when a second media file to be played requires additional time for buffering, the time period may be adjusted. In certain embodiments, when the media file is less than five seconds, the entire media file may be pre-loaded. In addition, a subsequent media file would then be pre-loaded. In one embodiment, the time period may range between one and ten seconds prior to the endpoint. The computing device may determine this time period during loading of a media file and/or during playback of a media file. The time period for pre-loading may be heuristically determined based on one or more of computer speed, network speed, drive speed, etc.

Selection of a media file by the media player application may be based on one or more sources selected by the user and may further be selected based on one or more user preferences. The media player application may be configured to store user preferences for determining media files to subsequently load. Similarly, the media player application can select one or more media files based on media file type (e.g., audio, video, etc.).

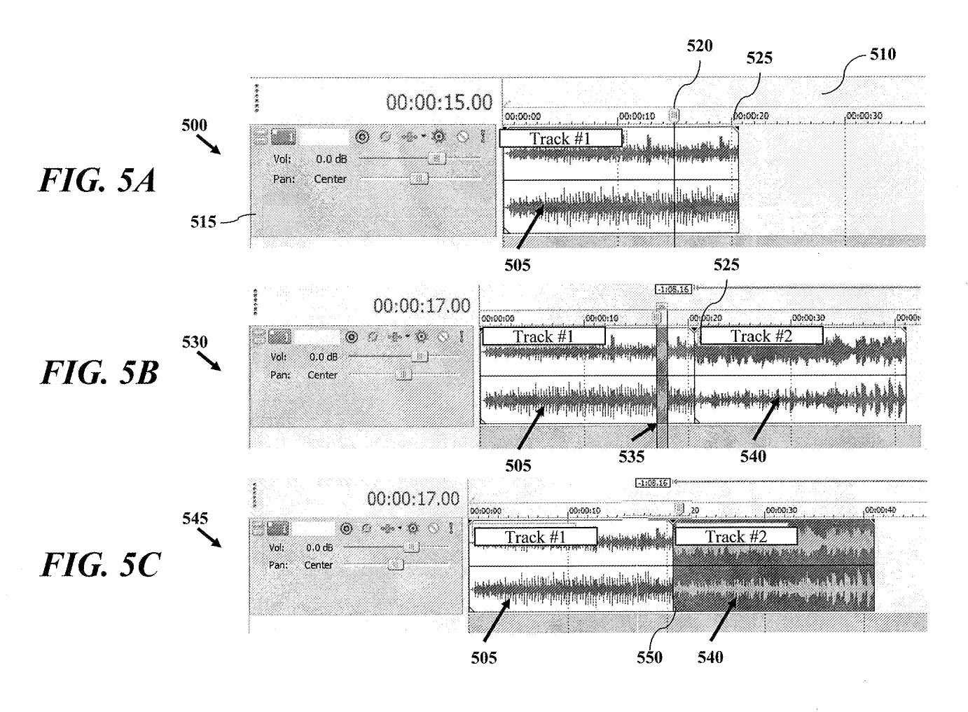

At block 420, the application of the computing device may then load data for a second media file at the time period determined at block 405. This pre-loaded data may relate to only a portion of the second media file. In one embodiment, a buffer portion is pre-loaded, the buffer portion relating to only the initial period of the playback for the second media file. As will be discussed in more detail below with reference to FIGS. 5A-5C, the buffer portion may be pre-loaded in the time interval between the time period and the end time of the first media file. It may also be appreciated that header data associated with the media file may additionally be decoded during preloading of the buffer data in order to determine an endpoint of the media file for subsequent determinations of endpoints. The application may additionally buffer data for one or more additional media files.

At block 425, the application can initiate playback of the second media file following termination of the first media file. By initiating data for the second media file, a seamless transition may be provided for playback wherein data from the second file is played immediately following the first media file without a delay between output of the media file data. In certain embodiments, initiating playback of the second media file at block 425 may be based on the media player application that is already on as described above with reference to block 410. Playback at block 425 may additionally include converting and sending media data to an already prepared media player application. The application can then continue playback of the second media file following termination of the buffer period at block 430. By way of example, the second media file may be loaded after the endpoint of the first media file and during playback of the previously decoded buffer portion. The remaining portion of the second media file may then be output seamlessly following the buffer portion. Accordingly, media files may be seamlessly output by the computing device.

One advantage of the invention over conventional methods may be that the media player application can continue process 400 without requiring user selection and placement of files to provide seamless playback. The media player application may be configured to play media files from different sources. Accordingly process 400 may include obtaining a first media file stored on the computing device, and a second media file stored on a second device separate and distinct from the computing device, such as devices via wide area network (WAN), a mobile device, etc. According to yet another embodiment, the first and second media files may relate to different types of file data. For example, the first media file can relate to audio data, and the second media file can relate to video data. Further, when media data is selected by the user, the media player can continue to select additional tracks from user specified locations until stopped by the user. According to another embodiment, media files may be randomly selected based on one or more libraries identified by the user.

Another advantage of the media player application may be conversion of media files to a standard file format by the application, wherein the first and second media files are associated with different file formats. For audio data, media files may be converted to a single audio format, such as 16 bit data at 44.1 kHz stereo by the media player application. This can facilitate providing continuous data and removing possible sources of delay during playback. In certain embodiment, it may be required to convert media files to a single output stream to allow for playback of an audio device. Although not shown in FIG. 4, process 400 may additionally include displaying output level data of the second media file, during playback of the first media file. Displaying a window of the user interface may include displaying a user interface of the application, by the computing device, including one or more of a graphical representation of audio data and video data associated with a media file during playback

Referring now to FIGS. 5A-5C, graphical representations are depicted of a media player application provided by a computing device. Referring first to FIG. 5A, a window of the media player application is shown as 500. Based on a user selection, the media player application may display a graphical representation of a media file, shown as 505, in user interface 510 of the media player application. In one embodiment, a user selection may be detected during execution of a media player application to play one or more media files. According to another embodiment, the user selection may be based on user selection of an icon, file folder, drop down menu, and media file of the computing device vie the computing device operating platform. User interface 510 may be configured to provide a graphical display of audio data associated with one or more tracks during playback. In one embodiment, user interface 510 includes pane 515 including one or more user controls, (e.g., selectable control terminals) for control of playback, such as play, stop, pause, forward, reverse, volume, etc.

As depicted in FIG. 5A, the media player application may display the current position for playback of the media file, shown as 520. Playback position 520 is depicted as a marker indicator, however it should be appreciated that it other variations may be employed. User interface 510 may additionally display a marker indicating the endpoint of the media file, shown as 525. The media player application may be configured to load data from a second media file prior to continuing playback of the first media file.

Referring now to FIG. 5B, a window of the media player application, shown as 530, is depicted according to another embodiment. Based on a user selection, the media application may be configured to output the media file alone, and/or may be configured to continuously play one or more media files. Playback of the one or more media files may be based on one or more sources previously indicated by the user, such as a user computing device, one or more devices coupled to the computing device and/or based on one or more file locations selected by the user. Sources of media files may include files on removable media, such as disc and memory cards, USB devices, and in some instances via network connections. Accordingly, a window 530 of the media player application is depicted based on user selected audio data. Window 530 includes audio data for a first media file 505 and second media file 540. In one embodiment, the media player application may be configured to employ the process described in FIG. 4 in order to initiate and continue playback of media file 540. As depicted in FIG. 5B, the media player application may determine a time period, shown as 535, prior to the endpoint of the first media file to select second media file 540. Further, the media player application may load an initial portion of second media file 540 during time period 535. In that fashion, the initial portion of second media file 540 may be decoded prior to the endpoint of first media file 505. Based on the decoding, the media application may determine one or more attributes of second media file 540, including duration. In certain embodiments, the media player application may additionally display a representation of the second media file while media file 505 is still playing, as shown in FIG. 5B.

Once playback of the first media file has completed, the media player may initiate playback of the buffer portion of the second media file as shown in FIG. 5C at position 550. The media player application may further begin decoding the remaining portion of the second media file at position 550. In one embodiment, the media player may decode the media file such that playback of the second media file is continuous.

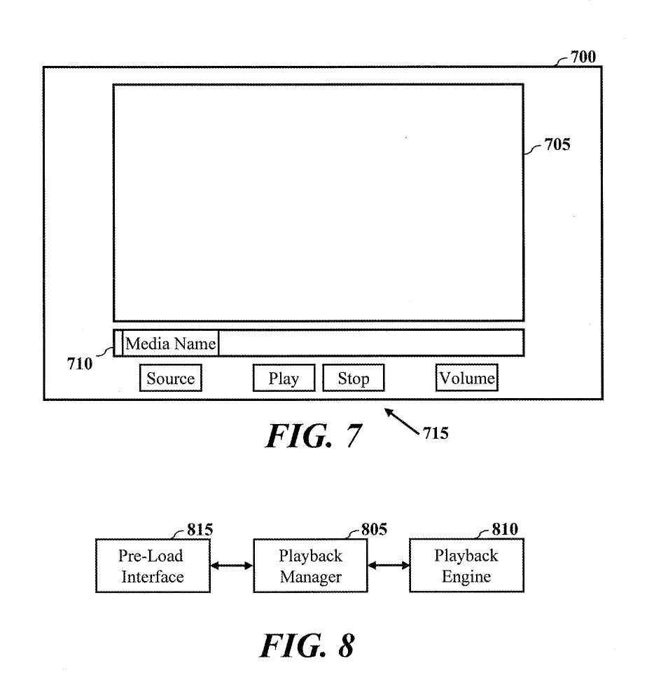

Although FIGS. 5A-5C depict playback of audio data, it should equally be appreciated that the media player application may additionally provide a display window including video data as will be described below with reference to FIG. 7.

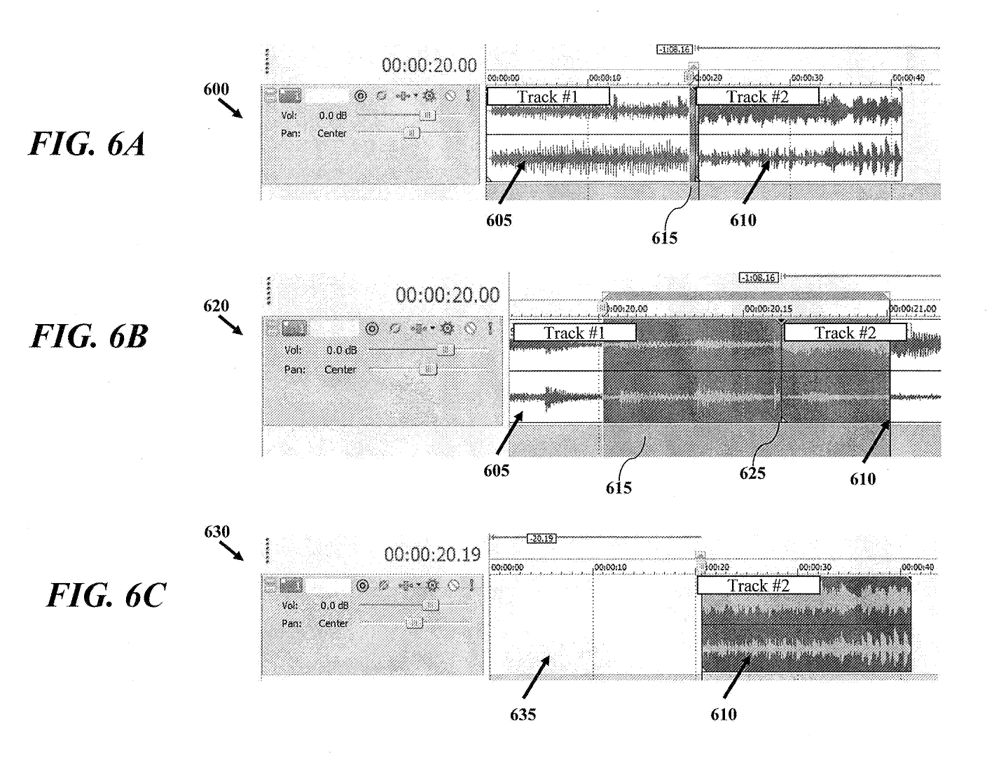

Referring now to FIGS. 6A-6C, graphical representations are depicted of seamless playback of a first media file and a second media file by the media player application of the computing device. Referring first to FIG. 6A, a window is displayed of the media player application, shown as 600. As depicted in window 600, playback of the first media file 605 is approaching the endpoint, shown as 615. FIG. 6B illustrates enlarged view of window 600, shown as window 620, depicting playback of the initial portion of the second media file following the first media file. According to one embodiment, the time period associated with period 615 may be 1 second. However it should be appreciated that the time period may range from 0.5 seconds to 10 seconds depending on the media file. By limiting the amount of data to a few seconds, the media player application can reduce the amount of memory required for providing a seamless transition between media files.

Referring now to FIG. 6C, window 630 is shown of the media player application once the first media file is completed and the second media file is being output. The media player application may adjust the display to indicate that the first media file has been completed by removing graphical data associated with the media file, indicated by 635. In certain embodiments, the media player application may free resources associated with a previously played file, including file handles, buffered data, memory allocated for the header of the file, etc. The media player application may just display the second media file, such as for video applications, once the first media file is completed.

Referring now to FIG. 7, a graphical representation is depicted of a media player application according to one embodiment. Media player application 700 may display video data associated with a media file during playback, shown as 705. Media player application 700 may further include identification of the media file name 710, and one or more user controls, such as play, stop, and/or selection of a source or library, shown as 715. During playback of one or more files including audio data, the media player application may display a graphical illustration and/or data associated with the media file (e.g., sound levels).

Referring now to FIG. 8, a graphical representation is depicted of functions of the media player application according to one embodiment. A media player application as described herein may include functions associated with a playback manager 805, playback engine 810 and pre-load thread 815. Playback manager 805 may be configured to handle start and stop requests, and loading media files. In certain embodiments, playback manager 805 may be configured to include a separate timer to determine when a file is close to complete, or when the file is completed and can be released. When a new file is close to complete, playback manager 805 can signal the pre-load thread 815 to decode data for pre-loading.

Playback engine 810 may allow for buffering of subsequent media tracks, and output of sound to a device. In one embodiment playback engine 810 may be configured to request data from playback manager 805, and may further be configured to operate in linear time for loading one or more media files. Pre-load thread 815 may be configured to open media files to determine a format and type. Based on the format and type, pre-load thread 815 can also notify playback manager 805 when an open file is completed.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for seamless playback of media files by an application of a computing device, the method comprising the acts of:
detecting a user selection for playback of one or more media files by the application;
initiating playback of a first media file, by the application, based on the user selection, wherein the first media file is output by the computing device;
determining a time period to pre-load a second media file, by the application, during playback of the first media file;
pre-loading data for the second media file, by the application, at the time period, wherein a buffer portion including data for an initial playback period of the second media file is pre-loaded;
initiating playback of the buffer portion following an endpoint of the first media file, wherein data for an initial playback period of the second media file is output by the computing device; and
continuing playback of the second media file following the endpoint of the buffer portion, wherein the remaining portion of the second media file is output by the computing device.

2. The method of claim 1, wherein the time period to pre-load the second media file is based on the duration of the first media file.

3. The method of claim 1, wherein pre-loading data for said second media file includes decoding the buffer portion of data and loading the buffer data for playback at the endpoint of the first media file.

4. The method of claim 1, wherein initiating playback of the buffer portion of the second media file relates to a seamless transition, wherein data from the second media file is played immediately following the first media file without delay between output of the media data.

5. The method of claim 1, further comprising loading the remaining portion of the second media file after the endpoint of the first media file and the decoding the remaining portion of the second media file is during playback of the buffer portion.

6. The method of claim 1, further comprising converting media file data to a single file format by the application when the first and second media files are associated with different file formats.

7. The method of claim 1, wherein the first media file is stored on the computing device, and the second media file is stored on a second device separate and distinct from the computing device.

8. The method of claim 1, wherein the first media file corresponds to audio data, and the second media file corresponds to video data.

9. The method of claim 1, further comprising selecting one or more media files by the application based on one or more storage locations identified by the user for playback until receiving a user request to stop playback.

10. The method of claim 1, wherein the first and second media files are randomly selected by the application based on one or more storage locations identified by the user.

11. The method of claim 1, further comprising displaying a user interface of the application, by the computing device, including one or more of a graphical representation of audio data and video data associated with a media file during playback.

12. A device comprising:
a user interface;
a display; and
a processor coupled to the user interface and the display, the processor configured to execute an application to:
detect a user selection for playback of one or more media files;
initiate playback of a first media file based on the user selection, wherein the first media file is output by the device;
determine a time period to pre-load a second media file during playback of the first media file;
pre-load data for the second media file at the time period, wherein a buffer portion including data for an initial playback period of the second media file is pre-loaded;
initiate playback of the buffer portion following an endpoint of the first media file, wherein data for an initial playback period of the second media file is output by the device;
and
continue playback of the second media file following the endpoint of the buffer portion, wherein the remaining portion of the second media file is output by the device.

13. The device of claim 12, wherein the time period to pre-load the second media file is based on the duration of the first media file.

14. The device of claim 12, wherein pre-loading data for said second media file by the processor includes decoding the buffer portion of data and loading the buffer data for playback at the endpoint of the first media file.

15. The device of claim 12, wherein initiating playback of the buffer portion of the second media file by the processor relates to a seamless transition, wherein data from the second media file is played immediately following the first media file without delay between output of the media data.

16. The device of claim 12, wherein the processor is further configured to load the remaining portion of the second media file after the endpoint of the first media file and decode the remaining portion of the second media file during playback of the buffer portion.

17. The device of claim 12, wherein the processor is further configured to convert the media files to a single file format by the application when the first and second media files are associated with different file formats.

18. The device of claim 12, wherein the first media file is stored on the device, and the second media file is stored on a second device separate and distinct from the device.

19. The device of claim 12, wherein the first media file corresponds to audio data, and the second media file corresponds to video data.

20. The device of claim 12, wherein the processor is further configured to select one or more media files by the application based on one or more storage locations identified by the user for playback until receiving a user request to stop playback.

21. The device of claim 12, wherein the first and second media files are randomly selected by the application based on one or more storage locations identified by the user.

22. The device of claim 12, further comprising displaying a user interface of the application including one or more of a graphical representation of audio data and video data associated with a media file during playback.

23. A computer program product comprising a computer readable medium encoded with executable code for seamless playback of media files, the computer program product comprising:
computer executable code to detect a user selection for playback of one or more media files;
computer executable code to initiate playback of a first media file based on the user selection, wherein the first media file is output by the device;
computer executable code to determine a time period to pre-load a second media file during playback of the first media file;
computer executable code to pre-load data for the second media file at the time period, wherein a buffer portion including data for an initial playback period of the second media file is pre-loaded;
computer executable code to initiate playback of the buffer portion following an endpoint of the first media file, wherein data for an initial playback period of the second media file is output by the device; and
computer executable code to continue playback of the second media file following the endpoint of the buffer portion, wherein the remaining portion of the second media file is output by the device.

24. The computer program product of claim 23, wherein the time period to pre-load the second media file is based on the duration of the first media file.

25. The computer program product of claim 23, wherein pre-loading data for said second media file by the processor includes decoding the buffer portion of data and loading the buffer data for playback at the endpoint of the first media file.

26. The computer program product of claim 23, wherein computer executable code to initiate playback of the buffer portion of the second media file comprises computer executable code to provide a seamless transition, wherein data from the second media file is played immediately following the first media file without delay between output of the media data.

27. The computer program product of claim 23, further comprising computer executable code to load the remaining portion of the second media file after the endpoint of the first media file and decode the remaining portion of the second media file during playback of the buffer portion.

28. The computer program product of claim 23, further comprising computer executable code to convert the media files to a single file format by the application when the first and second media files are associated with different file formats.

29. The computer program product of claim 23, wherein the first media file is stored on the device, and the second media file is stored on a second device separate and distinct from the device.

30. The computer program product of claim 23, wherein the first media file corresponds to audio data, and the second media file corresponds to video data.

31. The computer program product of claim 23, further comprising computer executable code to select one or more media files by the application based on one or more storage locations identified by the user for playback until receiving a user request to stop playback.

32. The computer program product of claim 23, wherein the first and second media files are randomly selected by the application based on one or more storage locations identified by the user.

33. The computer program product of claim 23, further comprising computer executable code to display a user interface of the application including one or more of a graphical representation of audio data and video data associated with a media file during playback.
